(19) United States
(12) Patent Application Publication
(10) Pub. No.: US 2025/0199379 A1
(43) Pub. Date: Jun. 19, 2025

(54) Low Power Frequency Modulated Continuous Waveform Compression To Femtosecond Pulses Using SCG And Pulse Compression

(71) Applicant: Superlight Photonics B. V., Enschede (NL)

(72) Inventor: Haider ZIA, Enschede (NL)

(21) Appl. No.: 18/671,555

(22) Filed: May 22, 2024

Related U.S. Application Data
(60) Provisional application No. 63/610,512, filed on Dec. 15, 2023.
(60) Provisional application No. 63/564,768, filed on Mar. 13, 2024.

(51) Int. Cl. G02F 1/365; G02F 1/35; H01S 3/00; H01S 3/1106

(52) U.S. Cl. CPC G02F 1/365; G02F 1/3528; H01S 3/0057; H01S 3/1106

(57) ABSTRACT

An optical system includes an optical source and a pulse shaping waveguide segment in optical communication with the optical source. The optical source is configured to generate a frequency modulated (FM) coherent waveform having a periodic phase profile. The pulse shaping waveguide segment shaping waveguide segment includes a plurality of subsegments. Each of the subsegments has a prescribed dispersion profile and length such that an overall group velocity dispersion (GVD) of the pulse shaping waveguide segment reduces a phase function of the FM coherent waveform in frequency space to provide an output of optical pulses. A waveguide structure may be in optical communication with the pulse shaping waveguide segment. The waveguide structure includes a plurality of alternating segments of normal dispersion (ND) waveguide segments and anomalous dispersion (AD) waveguide segments along a length of the waveguide structure to cause supercontinuum spectral generation of optical pulses traversing the waveguide structure.

### CROSS REFERENCE TO RELATED APPLICATION

This application claims the benefit of U.S. Provisional Application Ser. No. 63/610,512, filed Dec. 15, 2023 entitled “LOW POWER FREQUENCY MODULATED CONTINUOUS WAVEFORM COMPRESSION TO FEMTOSECOND PULSES USING SCG AND A NOVEL PULSE COMPRESSION TECHNIQUE” and U.S. Provisional Application Ser. No. 63/564,768, filed Mar. 13, 2024 entitled “LOW POWER FREQUENCY MODULATED CONTINUOUS WAVEFORM COMPRESSION TO FEMTOSECOND PULSES USING SCG AND PULSE COMPRESSION”, the contents of each application is incorporated herein by reference.

### BACKGROUND

Increasing information transmission within datacenters is becoming a key problem of the 21^{ST} century. With the advent of new AI models and technologies as well as the accessibility of cloud and internet services, the demand for data processing and transmission will increase exponentially. As intense data processing applications become mainstream, computation will be shifted to datacenters through cloud services. Therefore, the rate of data exchange between modules and nodes in the datacenter must dramatically increase.

This demand for increased data rates requires substantial increases in the optical bandwidth of transceivers, which are devices that convert electronic signals into optical signals and vice versa. Transceivers are used as the basic unit needed to connect the nodes in a datacenter. As this bandwidth increases, however, the energy demand also increases accordingly. The need for larger bandwidth transceivers, which occupy the same form factor and use the same amount of energy as conventional transceivers, remains an ongoing problem for data communications.

Understanding how data rates can be increased requires an examination of the specifics of the communication medium. In data communications, communication is facilitated through near-infrared electromagnetic waves divided into channels. These channels guide the waves through optical fibers, offering extensive bandwidth and minimal signal loss compared to traditional electronic wiring. Each channel corresponds ideally to a single wavelength of light, and the number of channels determines the volume of information transmitted concurrently. The modulation rate per channel represents the maximum rate at which bits per second can be converted from an RF signal carrying data to the optical signal traveling through the channel.

The conversion of an RF signal to an optical signal can be accomplished by intensity modulation of the optical channel (where e.g., 1 corresponds to transmission, 0 corresponds to absorption), by phase modulation or interferometric amplitude modulation schemes. Whatever the modulation scheme, the total information rate that can be transmitted is represented by:

$$total information / s = \# of Channels \times Modulation rate \qquad Eq . 1$$

It is clear from this equation that increasing the number of channels in a scalable way and/or increasing the data rate per channel increases the information rate. Past efforts have increased the modulation rate per channel or increased the number of channels, i.e., the bandwidth.

However, increasing the number of channels is challenging. In an optical transmitter module, this requires an array of lasers, usually vertical-cavity surface-emitting lasers (VCSELs), with each operating at a unique wavelength. In any case, whatever solution is employed must be energy efficient and scalable. Arrays of VCSELs dissipate a significant portion of power in data centers and are difficult to scale, as each additional channel requires the integration of a new laser in the array.

Maximizing the modulation bitrate is one way to increase the information rate, and this approach has provided substantial improvements in datacenter performance. Currently, high-end RF signal generation accomplishes an RF and therefore, a modulator bitrate of 100 gbit/s. Scaling this further will require significant research and development in RF circuitry and new materials for optical modulators.

A different way of approaching the problem would be to increase the total number of channels by using a pulse train of near-infrared (NIR) light, where each pulse exhibits high coherence with the previous one. Such a pulse train yields discrete channels of wavelengths in the spectrum due to the Fourier property of periodic signals. This source is known as a frequency comb. A significant advantage of such sources is that VCSEL arrays are not needed because in principle all the different channels are available from a single laser source. The large scalability of the bandwidth, combined with the cost and energy savings of such seed lasers, make them very attractive for use in replacing the more conventional VCSEL arrays.

However, the channels provided by the single laser source must be spatially separated into separate waveguides and modulated. For current technologies, this requires channel spacing that are greater than 10 GHz. In addition, it would be preferable if the frequency comb source occupies a small footprint such that it could fit in the standard transceiver form factor that is commonly used in industry. Essentially, an integrated comb laser is required. Currently, an optical source that fulfills these requirements are FM modulated quantum-dot (QD) lasers.

The number of channels available from current QD lasers is limited to about 12-20. However, for a data rate of 100s of terabits/s, which is the data rate that is expected to be needed based on current trends in demand, the number of channels would have to be greater than 200. Therefore, the QD laser is insufficient by itself for use as a coherent multichannel laser source for data communication applications. Such a laser would have to be combined with a spectral broadening mechanism to increase the number of channels.

One of the most accessible optical methods for increasing bandwidth is Supercontinuum Generation (SCG). Typically, SCG is accomplished in optical fibers or waveguides using pulsed optical radiation with pulses lasting less than 1 picosecond. However, the increase in bandwidth does not increase rapidly with higher pulse energy. To achieve this, lasers with nanojoule to microjoule pulse energies (Watt-level average power) are typically needed.

Integrated Quantum Dot (QD) lasers, on the other hand, produce pulses with energies ranging from 4 to 20 picojoules (after pre-amplification). This pulse energy range is consistent across all laser sources operating at line spacings greater than a gigahertz due to lower steady-state gain inversion within the laser's gain medium. This significant difference in pulse energy constraints makes conventional SCG unsuitable for use as a method for increasing spectral bandwidth, and therefore makes the number of channels available from QD lasers and high-frequency lasers in general unsuitable as well.

### SUMMARY OF THE INVENTION

In one aspect, a waveguide structure is described herein that is able to accomplish Supercontinuum Generation (SCG) using a laser source such as quantum dot laser or the like, which outputs a frequency modulated (FM) coherent waveform having a periodic phase profile.

Such a waveguide structure may be realized, in one embodiment, by providing the structure with a pulse shaping waveguide segment that is in optical communication with an optical source that generates a frequency modulated (FM) coherent waveform having a periodic phase profile. The pulse shaping waveguide segment includes a plurality of subsegments, each of the subsegments having a prescribed dispersion coefficient and length such that an overall group velocity dispersion (GVD) of the pulse shaping waveguide segment reduces a phase function of the FM coherent waveform in frequency space to provide an output of optical pulses. The waveguide structure also includes additional waveguide segments in which the optical pulses from the pulse shaping waveguide segment propagate. These additional segments include a plurality of alternating segments of normal dispersion (ND) waveguide segments and anomalous dispersion (AD) waveguide segments in which the optical pulses undergo SCG. This chain of sign-alternating dispersion waveguide segments are configured with an appropriate distribution of lengths and dispersion coefficients so that alternating temporal focusing and defocusing is imposed on the optical pulses, thereby avoiding soliton formation, spectral narrowing, as well as loss of peak intensity, while self-phase modulation increases the spectral bandwidth without undesirable spectral clamping.

In some embodiments, the pulse shaping waveguide segment is located at the beginning of the waveguide structure. In other embodiments the pulse shaping waveguide segment may be located at an intermediate location, either between adjacent sign-alternating dispersion waveguide segments or within a sign-alternating dispersion waveguide segment. In some embodiments the waveguide structure may include two or more pulse shaping waveguide segments located at different places within the chain of waveguide segments.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating supercontinuum generation in a generic waveguide structure having a chain of segments of alternating normal dispersion (ND) and anomalous dispersion (AD) as one progresses along the overall length of the waveguide structure.

FIG. 2 shows an example of an FM modulated optical output signal.

FIG. 3 shows an example of a periodic FM waveform (a frequency comb) in the time domain.

FIG. 4 shows an example of a pulsed waveform that is obtained by minimizing the phase function of the periodic FM waveform shown in FIG. 3.

FIG. 5 is a schematic diagram of a chain of sign-alternating dispersion waveguide segments similar to that shown in FIG. 1, except that the chain in FIG. 5 includes an initial pule shaping waveguide segment that precedes the sign-alternating dispersion waveguide segments of the overall waveguide structure.

FIG. 6A, FIG. 6B and FIG. 6C are schematic drawings of three examples of a chain of sign-alternating dispersion waveguide segments in which a pulse shaping waveguide segment is located as the initial waveguide segment of the chain.

FIG. 7 shows a schematic block diagram of an arrangement for performing SCG.

FIG. 8A shows the power in the center wavelength of the channels output by a waveguide structure as described herein in the form of a bar graph and FIG. 8B shows the power spectral density plotted against wavelength; FIG. 8C shows the gain spectrum of a semiconductor optical amplifier; and FIG. 8D shows the normalized intensity of a pulse output by the waveguide structure versus time.

FIG. 9 shows one example of a method of supercontinuum generation.

FIG. 10 shows a schematic block diagram of one example of a frequency synthesizer that serves as an optical transmitter in which a SCG waveguide structure as described herein may be employed.

### DETAILED DESCRIPTION

U.S. patent application Ser. No. 16/204,614, filed Nov. 29, 2018, now U.S. Pat. No. 10,859,889, which is incorporated by reference herein in its entirety, describes a technique for improved supercontinuum generation (SCG) that re-shapes pulses during, before or after nonlinear generation such that it maintains an ideal temporal shape for enhanced spectral generation. This technique is based on alternating the dispersion of a length of waveguide via alternating segments of normal and anomalous waveguide segments. The sign-alternating dispersion waveguide segments generate more spectral bandwidth than is possible using conventional techniques. This is accomplished by removing the spectral clamping mechanisms that required high pulse energies to overcome. The alternating segments also enhance the high-quality-3 dB spectral bandwidth and allow the spectral shape of the output to be tailored. A waveguide composed of appropriately designed segments with alternating dispersion allows full control over the spectral and phase dynamics, while preserving full coherence. The increased interaction length of the spectral generation process reduces the threshold for SCG, which increases the conversion efficiency.

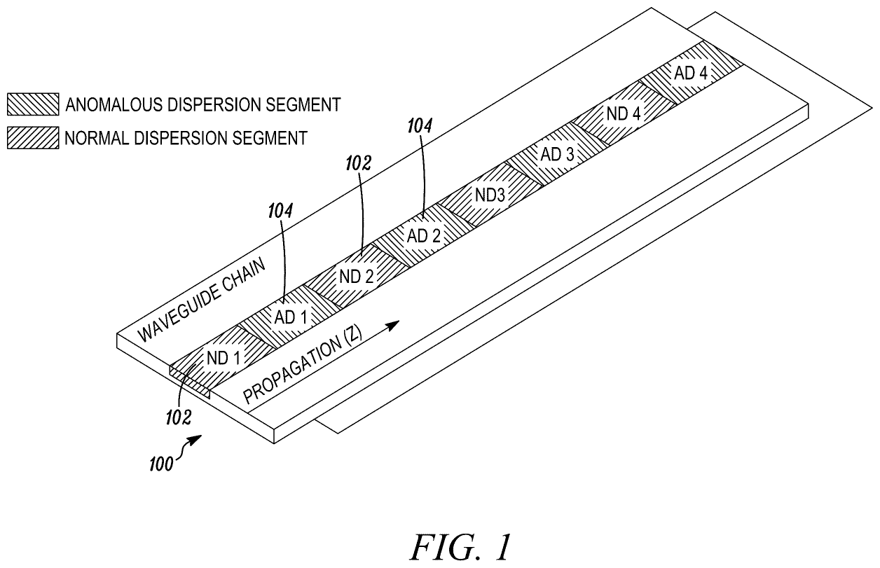

More specifically, FIG. 1 is a schematic diagram illustrating supercontinuum generation in a generic waveguide structure 100 (e.g., integrated or fiber waveguide) having a chain of segments of alternating normal dispersion (ND) 102 and anomalous dispersion (AD) 104 as one progresses along the overall length of the waveguide structure 100. Note that while the figure shows an ND segment 102 initially preceding an AD segment 104, the disclosure is not so limited, and such will be disclosed and discussed in more detail subsequently. A normal dispersion segment 102 refers to a waveguide segment having an overall group velocity dispersion (GVD) profile that is positive in value, usually expressed in units of s2/m versus angular frequency ω. An anomalous dispersion segment 104 refers to a waveguide segment having an overall group velocity dispersion (GVD) profile that is negative in value, also usually expressed in units of s2/m versus angular frequency ω. The different segments of the waveguide structure, including the subsegments of the pulse shaping segment, may be concatenated by mode converters that match the optical modes of the different segments and subsegments. For example, in some embodiments the mode converters may be adiabatically tapered waveguide segments.

For SCG the normal dispersion segments generate bandwidth through self-phase modulation (SPM). However, SPM and the dispersion work together to stretch out the pulse in time, reducing the peak power and clamping SCG. The AD segments compress and narrow the pulses in time, generating SPM through the increasing peak power and short duration. However, the AD segments also shape the pulses into solitons, which is a mathematically invariant solution in the nonlinear dynamics limiting further spectral generation. To account for these clamping effects, after the chirped, temporally stretched pulses have propagated through an ND segment of a certain length, the pulses are directed into an AD segment. The AD segment narrows the pulse in time and compresses it, generating bandwidth through the higher peak power. After the pulse chirp is minimized, the SPM generation process continues to nonlinearly compress the pulse so that its duration is decreased. Before soliton shaping occurs, or shortly after, the pulse is then directed into another ND segment to disrupt the soliton formation and continue bandwidth generation through the higher peak power of the pulse entering the ND segment. This process repeats for each additional pair of sign-alternating dispersion waveguide segments in the chain of segments that form the waveguide structure.

This technique for improving SCG has been demonstrated to reduce pulse energy requirements for SCG by orders of magnitude below the 10 pJ level. Therefore, this technique addresses the issue of extending the number of channels output by a QD laser through the use of SCG, thereby providing datacenters with the increasing number of channels that they are expected to need.

One problem that remains to be addressed, however, concerns how to adapt the sign-alternating dispersion waveguide segments of the waveguide structure to the type of frequency modulated waveforms that are output by QD lasers to enable them to be used as laser seeds for SCG. Addressing this problem would allow an arrangement that includes a QD laser butt coupled to the waveguide structure with sign-alternating segments for SCG to fit in the form factor currently defined for transceivers.

### Frequency Modulated Coherent Waveforms

Optical sources such QD lasers that would be beneficial to use as a laser source for data communication applications provide as an output Frequency Modulated (FM) coherent waveforms. The output from such lasers is constant in the intensity of optical radiation, like continuous-wave (CW) lasers, but with a phase that changes in time. Moreover, this phase pattern is not random, but is deterministic with a repeating phase pattern that can be simply expressed as:

$$A {e}^{i φ ( t )} = A [ cos φ ( t ) + i sin φ ( t ) ] \qquad Eq . 2$$

In Equation 2, the phase function is changing in time, while the amplitude remains constant. The real part of the electric field is a cosinal function where the distribution of instantaneous frequencies (i.e., ‘chirp’) are given as:

$$c ( t ) = \frac{d φ ( t )}{dt} \qquad Eq . 3$$

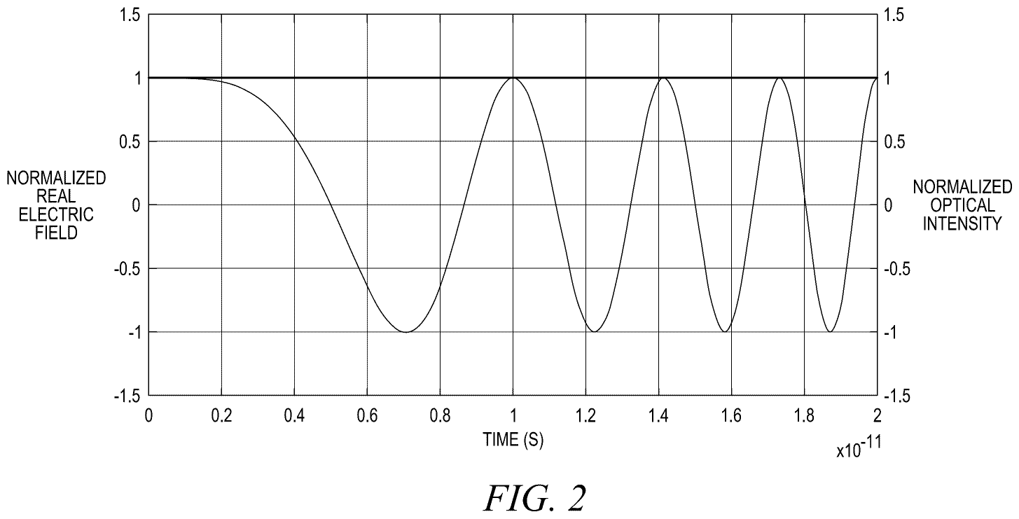

An example of such an FM modulated optical output is given in FIG. 2. In FIG. 2 the left y-axis represents the normalized real electric field versus time and the right y-axis represents the constant normalized optical intensity.

As previously mentioned, one property of integrated QD lasers is that they output FM waveforms with a repetitive phase pattern. However, one of their most useful properties is that their output represents frequency combs. In a frequency comb, there are a discrete set of frequencies separated by a constant spacing in frequency space. Each discrete frequency can be used as a channel for communication. Mathematically, a frequency comb is a set of delta functions (or narrow functions) centered at discrete locations in the frequency domain with a set spacing (e.g., greater than 10 GHz) between them.

It can be seen through the Fourier transform that a frequency comb is a periodic FM waveform in the time coordinate. The periodicity criterion in this case is imposed on the phase function so that the intensity remains constant in time. However, the phase function (φ_{P}), repeats itself after a certain time duration T. In the time domain the output obeys:

$$A {e}^{i {φ}_{P} ( t )} = A {e}^{i φ ( t - Tmod ( t , T ) )} \qquad Eq . 4$$

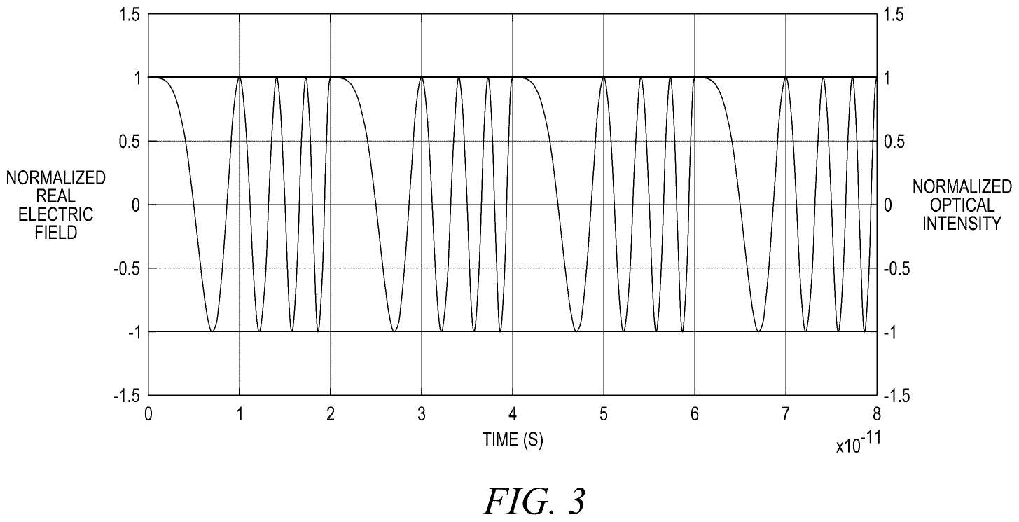

An example of a periodic FM waveform (a frequency comb) in the time domain is given in FIG. 3, where the left y-axis represents the normalized real electric field of the FM frequency comb versus time. The right y-axis in FIG. 3 represents the constant normalized optical intensity of the waveform The phase profile is the same profile as shown in FIG. 2, which in FIG. 3 repeats periodically with a period of 20 ps. The period of the signal is inversely proportional to the spacing of neighboring discrete comb lines in frequency space and is given as:

$${f}_{r e p} = 1 / T \qquad Eq . 5$$

### Transformation of FM Frequency Combs to Optical Pulses

Supercontinuum generation requires self-phase modulation (SPM) to take place. SPM, which is the primary bandwidth generation mechanism, requires the waveform to vary in intensity, ideally, in the form of pulses having a duration of less than 1 ps.

For SPM and SCG to take place, the output of the periodic FM waveforms must be converted to an amplitude modulated (AM) signal of compressed pulses in the time domain. By Fourier theory this can be accomplished by minimizing the phase function in frequency space, ideally to zero. The comb line amplitude and shape would be preserved but there would be a set of pulses in the time domain output, where each pulse is separated by T. Mathematically, the phase function across the frequency spectrum can be described as:

$$Phase ( ω ) = {\sum }_{j = 2}^{∞} \frac{1}{j !} {c}_{j} {ω}^{j} \qquad Eq . 6$$

Where j in the summation represents the coefficient order of the Taylor series.

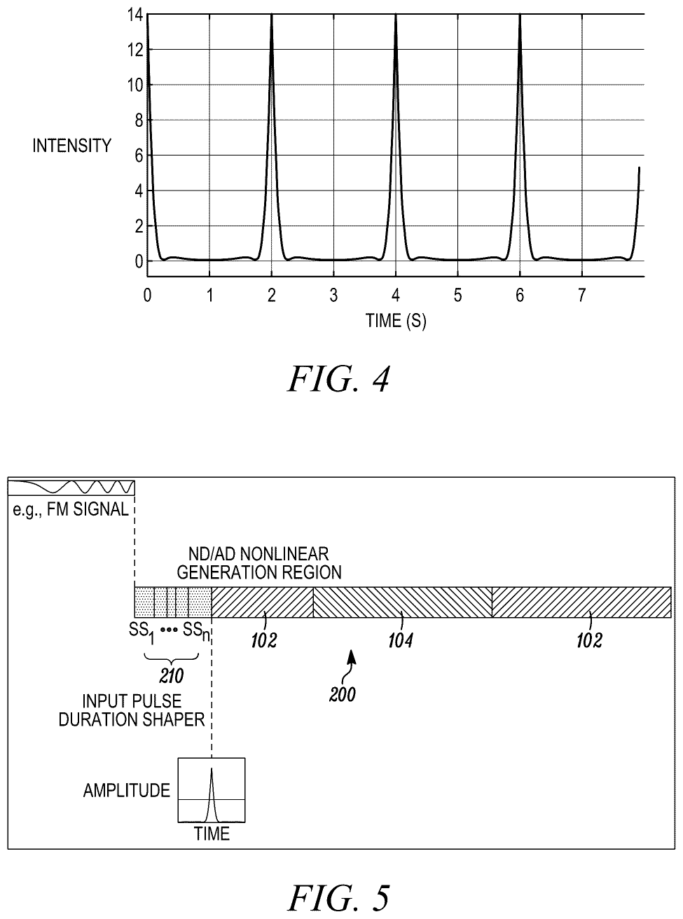

Minimizing the terms of this phase function transforms the periodic FM waveform output by the laser to an AM waveform and then to a pulsed waveform. FIG. 4 shows an example of the pulsed waveform that is obtained by minimizing the phase function of the periodic FM waveform shown in FIG. 3, which exhibits only a parabolic frequency phase (i.e., the chirp is parabolic in the time domain).

As explained below, the phase function can be minimized by allowing the periodic FM waveform to propagate through a waveguide segment, referred to herein as a pulse shaping waveguide segment, which has the opposite sign of the second order phase coefficient, such that the sum of both is zero. This can be accomplished using a pulse shaping waveguide segment that comprises multiple subsegments with particular values of their dispersion coefficients and lengths that are determined in the manner explained below.

### Choosing Dispersion Coefficients and Lengths of the Subsegments in the Pulse Shaping Waveguide Segment

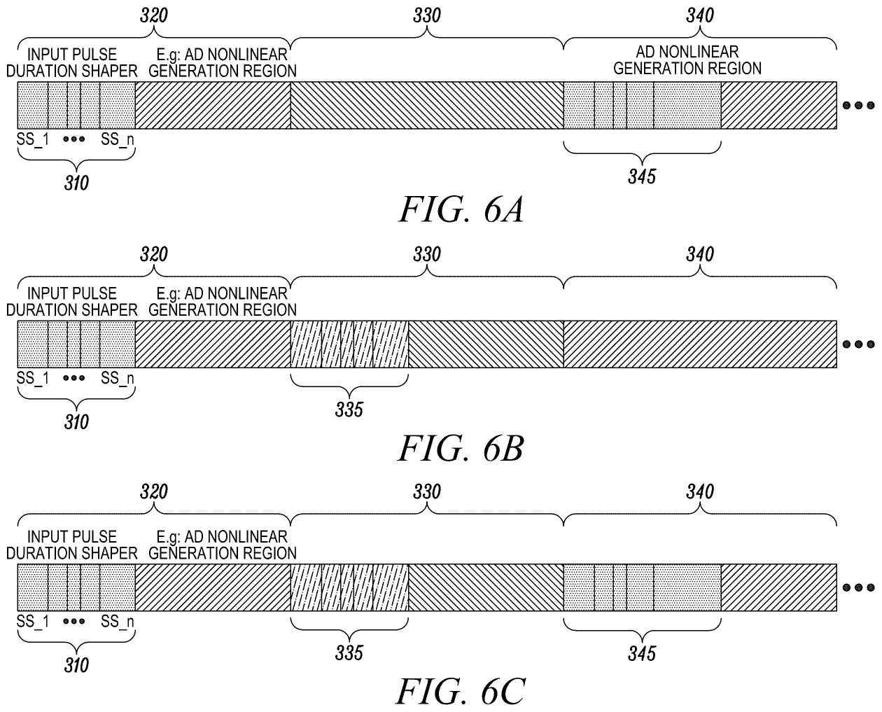

FIG. 5 is a schematic diagram of a chain 200 of sign-alternating dispersion waveguide segments similar to that shown in FIG. 1. In addition, however, the chain also includes an initial segment 210 that precedes the sign-alternating dispersion waveguide segments 102 and 104 of the overall waveguide structure. This initial segment 210 serves as the aforementioned pulse shaping waveguide segment that minimizes the phase function of the incoming periodic FM waveform from the laser source, converts it to an AM waveform and then to a pulsed waveform. This pulsed waveform is then directed into the sign-alternating dispersion waveguide segments for SCG, as described in previously mentioned U.S. patent application Ser. No. 16/204,614, now U.S. Pat. No. 10,859,889. As shown in FIG. 5, the pulse shaping waveguide segment 210 includes subsegments SS1, SS2 . . . SSN.

To accommodate the periodic FM waveforms in the chain of sign-alternating dispersion waveguide segments, in general, the pulse shaping waveguide segment 210 will be composed of subsegments, each subsegment SSn will have its own dispersion profile (i.e., the dispersion coefficient as a function of wavelength) such that the overall dispersion of the group of subsegments carries the defined sign of dispersion of the segment within the frequency range of interest. In particular, each of the subsegments SSn will compensate for a given phase order coefficient in Eq. 6. In this way the subsegments serve to compress the FM waveform into pulses that will undergo spectral broadening in the subsequent sign-alternating dispersion waveguide segments so that SCG occurs.

Each subsegment SSn in the chain of subsegments SS1, SS2 . . . SSN carries a certain group velocity dispersion (GVD) profile, that can be represented as:

$$G V {D}_{n} ( ω ) = {\sum }_{j = 2}^{∞} \frac{j ( j - 1 )}{j !} {d}_{j}^{n} {ω}^{j - 2} \qquad Eq . 7$$

where dⱼⁿ represents the dispersion coefficient of the nth segment and j represents the order of the dispersion coefficient. The value of the dispersion coefficient for each subsegment can be changed by tuning the width and/or the material composition of that subsegment. The overall GVD profile of the entire segment is then:

$$G V D ( ω ) = \frac{1}{{L}_{T}} {\sum }_{n = 1}^{N} {L}_{n} {\sum }_{j = 2}^{∞} \frac{j ( j - 1 )}{j !} {d}_{j}^{n} {ω}^{j - 2} \qquad Eq . 8$$

where Lₙ is the length of the subsegment and L_{T} is the segment length.

The integral of the GVD of a given subsegment multiplied by its length gives the additive or subtractive phase that would be given to the spectrum of a pulse traversing that subsegment. In mathematical terms, the pulse phase becomes:

$$Phase ( ω ) = Phase {( ω )}_{input} + \int \int GVD ( ω ) d {ω}^{2} \times L \qquad Eq . 9$$

Therefore, the GVD of the subsegments of the pulse shaping waveguide segment can account for the spectral phase of the input periodic FM waveform. Setting the left-hand side of Eq. 9 to zero and combining Eqs. 6-8, we obtain:

$${\sum }_{j = 2}^{∞} \frac{1}{j !} {c}_{j} {ω}^{j} = - {\sum }_{n = 1}^{N} {L}_{n} {\sum }_{j = 2}^{∞} \frac{1}{j !} {d}_{j}^{n} {ω}^{j} \qquad Eq . 10$$

To solve this equation the following steps and assumptions are made:
1. First, Eq. 6 is estimated up to the highest order given a desired accuracy. The Maclaurin series of the input phase spans this maximal order, labelled as J.
2. Eq. 10 then becomes an algebraic set of/equations and/unknowns. The subsegment length, Lₙ, are the unknowns and the total number of subsegments must equal J.
3. The dispersion coefficients, i.e., the d's in Eq. 8 for each subsegment, is determined in advance by solving for their widths and recording the resulting value of the GVD. As those of ordinary skill in the art will recognize, this can be accomplished, for example, by numerical eigenmode solvers. Therefore, the subsegment profiles (except for length) are known in advance and are the input values provided to Eq. 10.
4. It is assumed that the coefficients of the input phase Maclaurin series in Eq. 6 are known.
5 Regrouping like terms in the summation of Eq. 10 and eliminating common terms between the left-hand and right-hand sides, such as the angular frequency variable, yields the following set of algebraic equations:

$${c}_{j} = - {\sum }_{n = 1}^{J} {L}_{n} {d}_{j}^{n} ⋮ \\ {c}_{J} = - {\sum }_{n = 1}^{J} {L}_{n} {d}_{J}^{n} \qquad Eq . 11$$

The set of algebraic equations described by Eq. 11 can be solved using standard algebraic methods to obtain the unknown subsegment lengths Lₙ. However, solutions must be found where Lₙ≥0 and remain within practical limitations. For example, in some embodiments in which the waveguides are incorporated in a photonic integrated circuit (PIC), practical subsegment lengths Lₙ should be within the centimeter range. If these considerations are not met in any given solution to Eq. 11, then a new set of subsegments may be chosen with different dispersion coefficients.

Once the individual subsegments of the pulse shaping waveguide segment are determined, the resulting pulse shaping waveguide segment may be provided as the first segment in the chain of sign-alternating dispersion waveguide segments shown in FIG. 5. The pulse shaping waveguide segment can thus receive at its input the periodic FM waveform from the laser source and provide optical pulses at its output. The optical pulses can then be directed into the remaining chain of sign-alternating dispersion waveguide segments, where they can undergo SCG and nonlinear pulse compression. It should be noted that the pulse shaping waveguide segment does not necessarily have to compress the pulses down to the Fourier limit, but in some embodiments can allow for chirped pulses to form.

It is should also be noted that some applications may require nonlinear pulse compression in addition to SCG. The nonlinear dynamics of the sign-alternating dispersion waveguide segments compress the pulse in time in the AD segments. The duration of the pulses become progressively less as they propagate through subsequent AD segments due to the increased bandwidth generation. Therefore, large nonlinear pulse compression can transpire in such segments. For example, the duration of the pulses can decrease by factors close to 10 (i.e., durations 10 times less than the input duration). Sign-alternating dispersion waveguide structures are therefore highly efficient nonlinear compression waveguides that can operate in the low pulse energy regime. By adding the pulse shaping waveguide segment to them, these structures can serve as efficient nonlinear pulse compression structures for FM and long pulse, low energy seed laser sources.

In summary, efficient SCG can be accomplished using low pulse energy periodic FM waveforms from a laser source such as a quantum dot laser. In one embodiment, a chirped optical pulse or periodic FM signal from a laser source is directed into a waveguide structure that includes an initial pulse shaping waveguide segment having subsegments with lengths determined by Eq. 11, followed by sign-alternating dispersion waveguide segments in which SCG is performed. The initial pulse shaping waveguide segment adjusts the spectral phase of the radiation as it propagates in its various subsegments. Each subsegment has its own unique group velocity dispersion profile across frequency, which is achieved using waveguides that differ in width and/or material composition. As previously mentioned, the different segments of the waveguide structure, including the subsegments of the pulse shaping segment, may be concatenated by mode converters that match the optical modes of the different segments and subsegments. For example, in some embodiments the mode converters may be adiabatically tapered waveguide segments.

In some embodiments, in addition to transforming the periodic FM waveform or chirped pulse into optical pulses as described above, the pulse shaping waveguide segment may also perform spectral generation via the Kerr effect, where the nonlinear Schrodinger equation is used in the design process. The pulse shaping waveguide segment can compress the periodic FM waveform or chirped pulse to the Fourier limit or it can be designed to allow for chirped pulses (of shorter duration in the case of a chirped input pulse instead of a FM waveform).

In some embodiments the pulse shaping waveguide segment may include only a single subsegment, which is used to account for the second order phase if that is the only non-negligible phase present. In other embodiments, a plurality of subsegments is employed as described above.

Broadly speaking, the waveguide structure that is made up of various waveguide segments as described herein is a structure that guides optical waves with minimal loss of energy by restricting expansion to selected dimension(s). Such optical waveguides include both optical fiber and rectangular as well as non-rectangular (e.g., integrated) waveguides that are constructed to be spatially inhomogeneous such that the spatial region in which light propagates therein is restricted. As will be known by those skilled in the art, such optical waveguides will include a region exhibiting a different refractive index from surrounding region(s). In some embodiments the waveguide may be a dielectric waveguide, or more specifically a planar optical waveguide. The waveguide structure, including both the pulse shaping waveguide segments and the sign-alternating dispersion waveguide segments, may be formed from any suitable material system including, for example silicon-based systems and III-V semiconductor material systems. Illustrative waveguide structures that may be employed include, without limitation, silicon nitride on oxide waveguides, silicon on insulator waveguides, aluminum oxide waveguides and lithium niobate waveguides.

In some embodiments of the waveguide structure described herein the pulse shaping waveguide segment only performs pulse compression and does contribute to SCG, which only occurs in the subsequent chain of sign-alternating dispersion waveguide segments. In other embodiments, however, the pulse shaping waveguide segment may be treated as one of the sign-alternating dispersion waveguide segments, which performs both SCG and pulse shaping. In yet other embodiments the pulse shaping waveguide segment may be treated as being located within one of the sign-alternating dispersion waveguide segments such that SCG occurs within the entirety of that sign-alternating dispersion waveguide segment. The exact location of the pulse shaping waveguide segment within the chain may be determined by simulating the dynamics using the nonlinear Schrodinger equation that accounts for dispersive and nonlinear effects.

While the embodiments described above employ a single pulse shaping waveguide segment at the beginning of the chain of sign-alternating dispersion waveguide segments or at some intermediate location, in other embodiments one or more additional pulse shaping waveguide segments also may be located at some intermediate locations within the chain. These pulse shaping waveguide segments may be provided in chains that begin with an initial pulse shaping waveguide segment, as well as chains that do not include an initial pulse shaping waveguide. As noted above, the exact location of the pulse shaping waveguide segment(s) within the chain may be determined by simulating the dynamics using the nonlinear Schrodinger equation that accounts for dispersive and nonlinear effects.

For instance, in some embodiments, a pulse shaping waveguide segment may be located within one or more of the alternating ND or AD waveguide segments in which SCG occurs. In this way the pulse shaping waveguide segment can be used to compress or render the pulse into a temporal configuration, by tuning the spectral phase to maximize nonlinear generation in neighbouring ND or AD waveguide segments and/or within the pulse shaping waveguide segment itself. For example, satellite peaks that develop and increase modulations in the spectrum can be eliminated by temporal shaping within the AD segments of the waveguide structure.

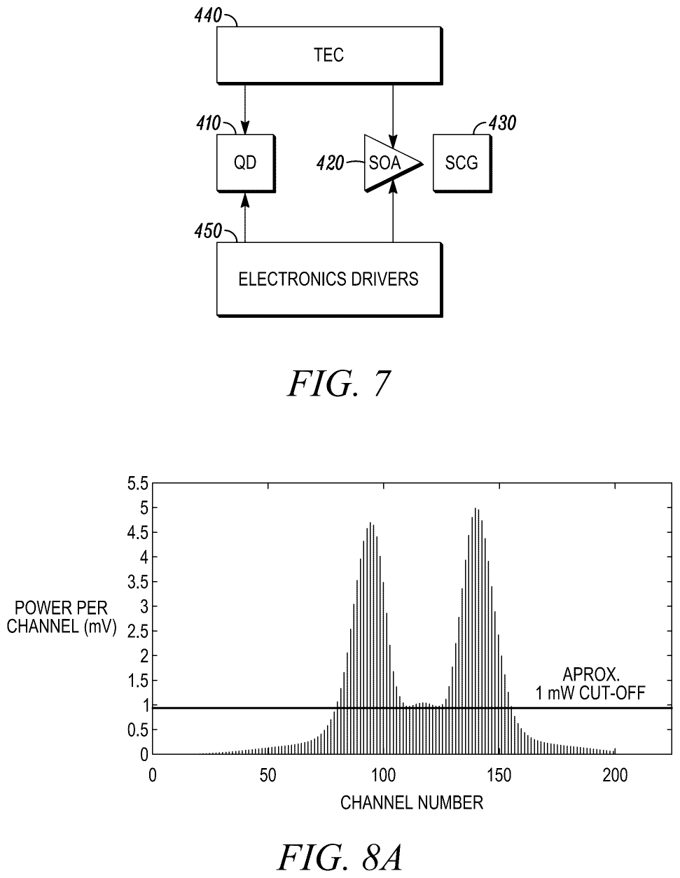

FIGS. 6a-6c are schematic drawings of three examples of a chain of sign-alternating dispersion waveguide segments in which a pulse shaping waveguide segment 310 is located as the initial waveguide segment of the chain, which includes AD waveguide segments 320 and 340 with a ND waveguide segment 330 interposed between them. In FIG. 6a an additional pulse shaping waveguide segment 345 is located within the AD waveguide segment 340 of the chain. This pulse shaping waveguide segment 345 can be used to optimize the pulse shape as it enters the neighbouring ND waveguide segments to increase SCG therein. FIG. 6b shows an additional pulse shaping waveguide segment 335 located within the ND waveguide segment 330 to optimize the pulse shape as the pulse enters the subsequent AD waveguide segment 340. FIG. 6c shows additional pulse shaping waveguide segments 335 and 345 respectively located within the ND and AD waveguide segments 330 and 340 to increase SCG in both segments.

As shown in FIG. 6, in some embodiments the pulse shaping waveguide segments located within ND and/or AD segments may be provided at the beginning of their respective ND or AD segments. In this way the pulse shaping waveguide segment can be used to tune the pulse shape to increase SCG within its respective ND or AD segment. More generally, such pulse shaping waveguide segments may be located at any point within an ND or AD segment.

In some embodiments the chain of waveguide segments that make up the waveguide structure may begin with a pulse shaping waveguide segment and terminate with an AD segment to order to perform nonlinear pulse compression. The duration of the output pulses from this waveguide structure is shorter than the duration of the waveforms that are directed into the input of waveguide structure.

It should be noted that while the waveguide structure that includes a pulse shaping waveguide segment as described herein has been described as reducing the phase function of a periodic FM modulated coherent waveform received from a laser source, the pulse shaping waveguide segment more generally may reduce the phase function of other optical pulsed or wide bandwidth waveforms, including non-transform limited optical pulses. In this regard a periodic FM modulated coherent waveform may be viewed as a particular case where the individual pulse length is equal to or longer than the time window of the repeating periodic signal.

In addition, while the laser source in the examples presented above have been described as a quantum dot laser, more generally the laser source may be any type of quantum element laser (e.g., a quantum-dash laser, a quantum wire laser, etc.) or other type of laser source able of generating waveforms of the types discussed above. For example, in some embodiments the laser source may be an integrated mode-locked laser.

### Illustrative Example

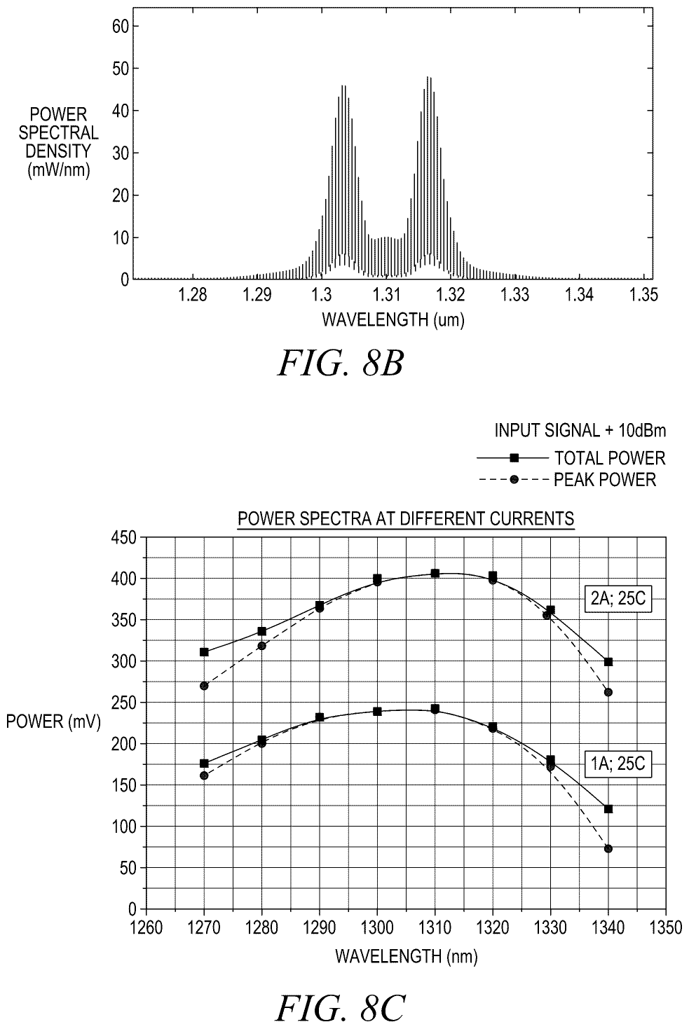

Simulations of the waveguide structure described herein have been performed. Described herein are simulations summarizing a waveguide structure that includes a chain of sign-alternating dispersion waveguides that incorporates a pulse shaping waveguide segment having a single subsegment. This waveguide structure successfully compresses the input periodic FM waveform from a QD integrated diode, outputting 200 mW of average power (4 pJ pulse energy) with a pulse separation of 50 GHz. Such a QD seed laser is readily available commercially. A schematic block diagram of an arrangement 400 for performing SCG is shown in FIG. 7 and includes a quantum diode laser 410, a semiconductor optical amplifier (SOA) 420 and the waveguide structure 430 described herein for performing SCG using as its input a periodic FM waveform from the laser. The SOA 420 performs pre-pulse amplification to account for coupling losses and operates in coordination with electronics drivers 450. A thermoelectric cooler (TEC) 440 is employed for temperature control.

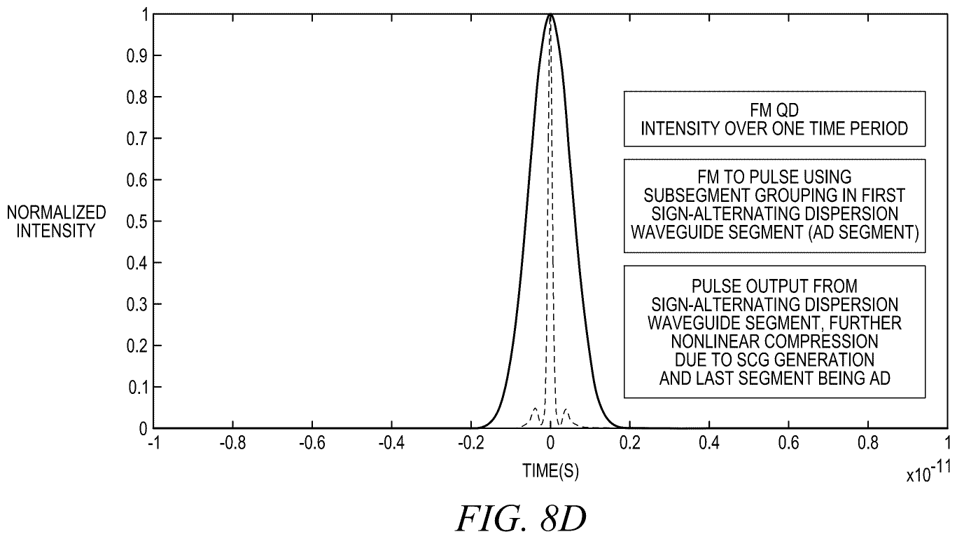

To quantify the number of useful channels generated by this waveguide structure, the power barrier of a channel is chosen to be 1 mW. FIG. 8a shows the power in the center wavelength of the channels output by the waveguide structure in the form of a bar graph that is labeled with the channel number. It should be noted that detectors such as InP detectors used in data communications have a NEP (noise equivalent optical power) that can go down to 10 uW per channel. At a power greater than 1 mW, the number of channels is 150, while the number of channels from the diode alone is 50. At a power level of 10 uW, the number of available channels is greater than 200. FIG. 8b shows the power spectral density plotted against wavelength. This plot shows the entire structure of the frequency comb output, where each comb line corresponds to one channel.

In some embodiments a design constraint is imposed on the waveguide structure so that spectral generation is limited to being within the bandwidth of a semiconductor optical amplifier (SOA) operating at the central wavelength of the QD laser (e.g., 1310 nm). This constraint ensures that post-amplification across the SCG spectrum is uniform and possible to achieve. FIG. 8c shows the SOA gain spectrum. The flat range of the gain spectrum surpasses that of the output spectrum; therefore, each channel can be equally amplified to a suitable level. Post-amplification may be needed for the transmission of data across large distances and for a variety of applications.

Finally, the sign-alternating dispersion waveguide structure used in the simulation terminated with an AD segment, such that the pulses at its output were highly compressed in comparison to the pulses provided by the initial pulse shaping waveguide segment located at the beginning of the structure. In particular, the pulses from the initial pulse shaping waveguide segment had a duration of 1.2 ps while the compressed pulses at the output of the sign-alternating dispersion waveguide had a duration of 13.2 fs, for a compression factor of 91. FIG. 8d shows the normalized intensity of the pulse versus time. It should be noted that the initial pulse shaping waveguide segment was not designed to compress the input FM waveform to the Fourier limit but to allow some chirp. The nonlinear dynamics within the AD waveguide segment that terminates the waveguide structure further compresses the pulse to the short duration indicated above.

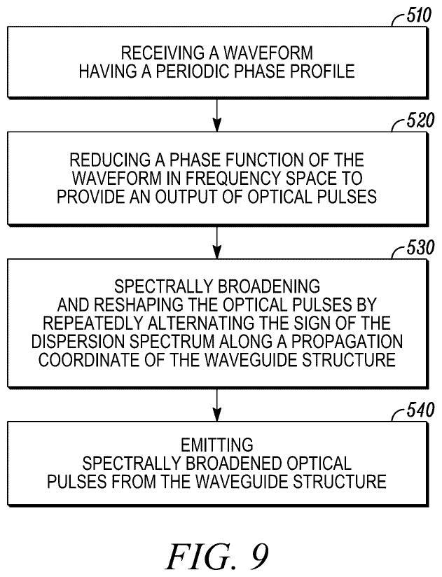

FIG. 9 shows one example of a method of supercontinuum generation. The method begins at block 510 when a waveform having a periodic phase profile is received. In some embodiments the waveform is a frequency modulated (FM) coherent waveform. In other embodiments the waveform is a non-transform limited optical pulse waveform. A phase function of the FM coherent waveform in frequency space is reduced at block 520 to provide an output of optical pulses. The optical pulses are spectrally broadened and reshaped at block 530 by repeatedly alternating the sign of the dispersion spectrum along a propagation coordinate of the waveguide structure. The waveguide structure includes alternating segments of normal dispersion (ND) waveguide and anomalous dispersion (AD) waveguide along a length of the waveguide structure. At block 540 the spectrally broadened optical pulses are emitted from the waveguide structure.

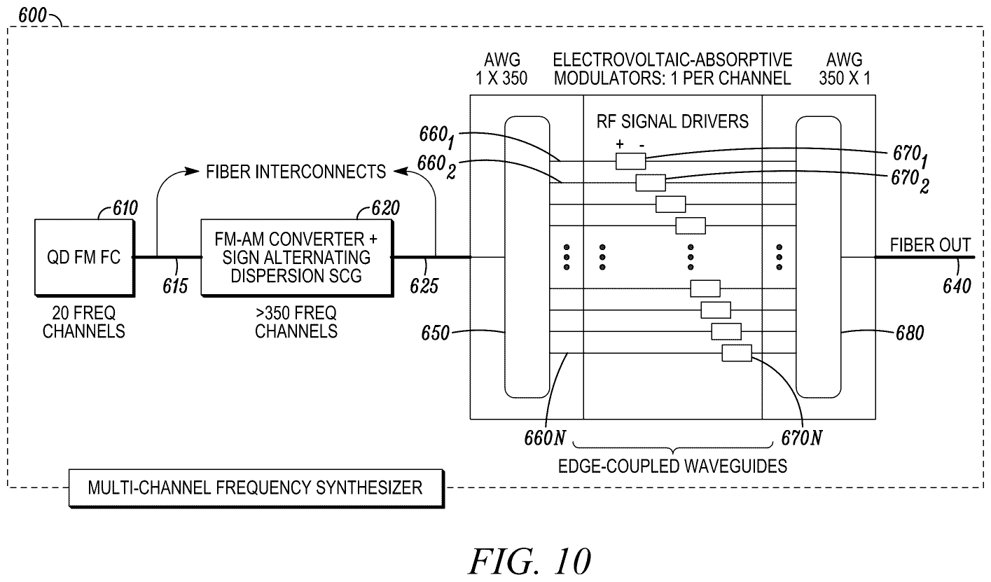

FIG. 10 shows a schematic block diagram of one example of a multichannel frequency synthesizer that serves as an optical transmitter 600 in which a SCG waveguide structure as described herein may be employed. The optical transmitter 600 includes a laser source such as quantum dot laser 610, SCG waveguide structure 620 and a modulation unit 630. The quantum dot laser 610 supplies a frequency comb that includes a plurality (e.g. 20 or more) of channels located at different frequencies to the SCG waveguide structure 620 over an optical fiber 615. The SCG waveguide structure 620 reduces a phase function of the plurality of channels to provide optical pulses that undergo supercontinuum generation to increase the available bandwidth and the available number of channels (e.g., from 20 to 350 or more). The optical pulses are directed over optical fiber 625 to the modulation unit 630. The modulation unit 630 modulates the individual channels with data and provides the resulting multiplexed, data modulated channels onto an output fiber 640.

In one particular embodiment, the modulation unit 630 may include a first arrayed waveguide grating (AWG) 650 that demultiplexes the channels onto waveguides 660₁, 660₂ . . . 660ₙ, which direct each channel to a respective data modulator 670₁, 670₂ . . . 670ₙ. In general, any suitable type of modulators may be employed, including, for example, electro-absorptive modulators. The individual data modulated channels on waveguides 660₂ . . . 660ₙ are directed to a second AWG 680 that multiplexes the data modulated channels onto an optical fiber 690. In some embodiments the modulators are data modulators that impart data to the channels using any suitable modulation scheme.

While FIG. 10 shows an optical transmitter 600, those of ordinary skill in the art will recognize that the optical transmitter may be incorporated into a transceiver module that includes the optical transmitter and a corresponding receiver in which a multiplexed optical signal is demultiplexed into individual channels and demodulated in an appropriate manner to generate RF data signals.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalent of the appended claims.

1. An optical system, comprising:
an optical source configured to generate a frequency modulated (FM) coherent waveform having a periodic phase profile;
a pulse shaping waveguide segment in optical communication with the optical source, the pulse shaping waveguide segment including a plurality of subsegments, each of the subsegments having a prescribed dispersion profile and length such that an overall group velocity dispersion (GVD) of the pulse shaping waveguide segment reduces a phase function of the FM coherent waveform in frequency space to provide an output of optical pulses.

2. The optical system of claim 1, further comprising a waveguide structure in optical communication with the pulse shaping waveguide segment, the waveguide structure including a plurality of alternating segments of normal dispersion (ND) waveguide segments and anomalous dispersion (AD) waveguide segments along a length of the waveguide structure.

3. The optical system of claim 2, wherein the alternating segments are configured such that supercontinuum spectral generation of optical pulses traversing the waveguide structure is affected in at least one or both of the AD and ND segments wherein the optical pulses are temporally compressed in one of the segment types and temporally expanded in the other one of the segment types and spectral clamping is absent in both segment types.

4. The optical system of claim 1, wherein the plurality of subsegments of the pulse shaping waveguide segment is configured to cause supercontinuum spectral generation of the FM coherent waveform traversing the pulse shaping waveguide segment.

5. The optical system of claim 3, wherein the plurality of subsegments of the pulse shaping waveguide segment is configured to cause supercontinuum spectral generation of the FM coherent waveform traversing the pulse shaping waveguide segment.

6. The optical system of claim 2, wherein the pulse shaping waveguide segment receives the FM modulated waveform from the optical source and provides the optical pulses that are output to the waveguide structure.

7. The optical system of claim 2, wherein the pulse shaping waveguide segment is located between two of the alternating segments of the waveguide structure such that a spectral phase of the optical pulses traversing the pulse shaping waveguide segment increases supercontinuum spectral generation in one or more subsequent ones of the alternating segments that the optical pulses traverse.

8. The optical system of claim 2, wherein the waveguide structure terminates with an AD waveguide segment to cause nonlinear pulse compression of the optical pulses.

9. The optical system of claim 2, wherein the pulse shaping waveguide segment is located within one of alternating segments of ND and AD waveguide segments.

10. The optical system of claim 2, further comprising at least one additional pulse shaping waveguide segment located within one of the alternating segments of ND and AD waveguide segments.

11. The optical system of claim 10, wherein the additional pulse shaping waveguide segment is located at a beginning portion of the alternating segment in which the pulse shaping waveguide segment is located.

12. The optical system of claim 2, further comprising at least one additional pulse shaping waveguide segment located between adjacent ones of the alternating segments of ND and AD waveguide segments.

13. The optical system of claim 8, wherein the terminating AD waveguide segment causes the optical pulses to have a duration less than a duration of the optical pulses output by the pulse shaping waveguide segment.

14. The optical system of claim 1, wherein the pulse shaping waveguide segment is a silicon nitride on oxide waveguide.

15. The optical system of claim 1, wherein the pulse shaping waveguide segment is a silicon on insulator waveguide.

16. The optical system of claim 1, wherein the pulse shaping waveguide segment is an aluminum oxide waveguide.

17. The optical system of claim 1, wherein the optical source is a quantum dot laser.

18. The optical system of claim 1, wherein the optical source is a mode-locked laser.

19. The optical system of claim 2, wherein the waveguide structure terminates with the pulse shaping waveguide to provide compressed pulses at the output of the waveguide structure.

20. An optical system, comprising:
an optical source configured to generate a non-transform limited pulsed optical waveform;
a pulse shaping waveguide segment in optical communication with the optical source, the pulse shaping waveguide segment including a plurality of subsegments, each of the subsegments having a prescribed dispersion coefficient and length such that an overall GVD of the pulse shaping waveguide segment reduces a phase function of the non-transform limited pulsed optical waveform in frequency space to provide an output of optical pulses.

21. The optical system of claim 20, further comprising a waveguide structure in optical communication with the pulse shaping waveguide segment, the waveguide structure including a plurality of alternating segments of normal dispersion (ND) waveguide segments and anomalous dispersion (AD) waveguide segments along a length of the waveguide structure.

22. The optical system of claim 21, wherein the alternating segments are configured such that supercontinuum spectral generation of optical pulses traversing the waveguide structure is effected in at least one or both of the AD and ND segments wherein the pulses are temporally compressed in one of the segment types and temporally expanded in the other one of the segment types and spectral clamping is absent in both segment types.

23. The optical system of claim 20, wherein the plurality of subsegments of the pulse shaping waveguide segment is configured to cause supercontinuum spectral generation of the non-transform limited pulsed optical waveform traversing the pulse shaping waveguide segment.

24. The optical system of claim 22, wherein the plurality of subsegments of the pulse shaping waveguide segment is configured to cause supercontinuum spectral generation of the non-transform limited pulsed optical waveform traversing the pulse shaping waveguide segment.

25. The optical system of claim 21, wherein the pulse shaping waveguide segment receives the non-transform limited pulsed optical waveform from the optical source and provides the optical pulses that are output to the waveguide structure.

26. The optical system of claim 21, wherein the pulse shaping waveguide segment is located between two of the alternating segments of the waveguide structure such that a spectral phase of the optical pulses traversing the pulse shaping waveguide segment increases supercontinuum spectral generation in one or more subsequent ones of the alternating segments that the optical pulses traverse.

27. The optical system of claim 21, wherein the waveguide structure terminates with an AD waveguide segment to cause nonlinear pulse compression of the optical pulses.

28. The optical system of claim 21, wherein the pulse shaping waveguide segment is located within one of alternating segments of ND and AD waveguide segments.

29. The optical system of claim 21, further comprising at least one additional pulse shaping waveguide segment located within one of the alternating segments of ND and AD waveguide segments.

30. The optical system of claim 29, wherein the additional pulse shaping waveguide segment is located at a beginning portion of the alternating segment in which the pulse shaping waveguide segment is located.

31. The optical system of claim 21, further comprising at least one additional pulse shaping waveguide segment located between adjacent ones of the alternating segments of ND and AD waveguide segments.

32. The optical system of claim 27, wherein the terminating AD waveguide segment causes the optical pulses to have a duration less than a duration of the optical pulses output by the pulse shaping waveguide segment.

33. The optical system of claim 19, wherein the pulse shaping waveguide segment is a silicon nitride on oxide waveguide.

34. The optical system of claim 20, wherein the pulse shaping waveguide segment is a silicon on insulator waveguide.

35. The optical system of claim 20, wherein the pulse shaping waveguide segment is an aluminum oxide waveguide.

36. The optical system of claim 20, wherein the optical source is a quantum dot laser.

37. The optical system of claim 20, wherein the optical source is a mode-locked laser.

38. The optical system of claim 21, wherein the waveguide structure terminates with the pulse shaping waveguide to provide compressed pulses at the output of the waveguide structure.

39. A method of supercontinuum generation, comprising:
receiving a waveform having a periodic phase profile, the waveform being a frequency modulated (FM) coherent waveform or a non-transform limited optical pulse waveform;
reducing a phase function of the FM coherent waveform in frequency space to provide an output of optical pulses;
spectrally broadening and reshaping the optical pulses by repeatedly alternating the sign of the dispersion spectrum along a propagation coordinate of the waveguide structure, said waveguide structure including alternating segments of normal dispersion (ND) waveguide and anomalous dispersion (AD) waveguide along a length of the waveguide structure;
emitting spectrally broadened optical pulses from the waveguide structure.

40. The method of claim 39, wherein the phase function of the waveform is reduced by transmitting the waveform through a waveguide structure in optical communication with the pulse shaping waveguide segment, the waveguide structure including a plurality of alternating segments of normal dispersion (ND) waveguide segments and anomalous dispersion (AD) waveguide segments along a length of the waveguide structure.

41. The method of claim 40, wherein the alternating segments are configured such that supercontinuum spectral generation of optical pulses traversing the waveguide structure is affected in at least one or both of the AD and ND segments wherein the pulses are temporally compressed in one of the segment types and temporally expanded in the other one of the segment types and spectral clamping is absent in both segment types.

42. The method of claim 39, wherein the plurality of subsegments of the pulse shaping waveguide segment is configured to cause supercontinuum spectral generation of the waveform traversing the pulse shaping waveguide segment.

43. The method of claim 41, wherein the plurality of subsegments of the pulse shaping waveguide segment is configured to cause supercontinuum spectral generation of the waveform traversing the pulse shaping waveguide segment.

44. The method of claim 40, wherein the pulse shaping waveguide segment receives the waveform from the optical source and provides the optical pulses that are output to the waveguide structure.

45. The method of claim 40, wherein the pulse shaping waveguide segment is located between two of the alternating segments of the waveguide structure such that a spectral phase of the optical pulses traversing the pulse shaping waveguide segment increases supercontinuum spectral generation in one or more subsequent ones of the alternating segments that the optical pulses traverse.

47. The method of claim 40, wherein the waveguide structure terminates with an AD waveguide segment to cause nonlinear pulse compression of the optical pulses.

48. The method of claim 40, wherein the pulse shaping waveguide segment is located within one of alternating segments of ND and AD waveguide segments.

49. The method of claim 40, further comprising at least one additional pulse shaping waveguide segment located within one of the alternating segments of ND and AD waveguide segments.

50. The method of claim 49, wherein the additional pulse shaping waveguide segment is located at a beginning portion of the alternating segment in which the pulse shaping waveguide segment is located.

51. The method of claim 40, further comprising at least one additional pulse shaping waveguide segment located between adjacent ones of the alternating segments of ND and AD waveguide segments.

52. The method of claim 47, wherein the terminating AD waveguide segment causes the optical pulses to have a duration less than a duration of the optical pulses output by the pulse shaping waveguide segment.

53. The method of claim 39, wherein the pulse shaping waveguide segment is a silicon nitride on oxide waveguide.

54. The method of claim 39, wherein the pulse shaping waveguide segment is a silicon on insulator waveguide.

55. The method of claim 39, wherein the pulse shaping waveguide segment is an aluminum oxide waveguide.

56. The method of claim 39, wherein the optical source is a quantum dot laser.

57. The method of claim 39, wherein the optical source is a mode-locked laser.

58. The method of claim 40, wherein the waveguide structure terminates with the pulse shaping waveguide to provide compressed pulses at the output of the waveguide structure.

59. An optical transceiver that includes an optical transmitter and an optical receiver, the optical transmitter, comprising:
an optical source configured to generate a frequency modulated (FM) coherent waveform having a periodic phase profile that defines a first plurality of channels;
a pulse shaping waveguide segment in optical communication with the optical source, the pulse shaping waveguide segment including a plurality of subsegments, each of the subsegments having a prescribed dispersion profile and length such that an overall GVD of the pulse shaping waveguide segment reduces a phase function of the FM coherent waveform in frequency space to provide an output of optical pulses; and
a waveguide structure in optical communication with the pulse shaping waveguide segment, the waveguide structure including a plurality of alternating segments of normal dispersion (ND) waveguide segments and anomalous dispersion (AD) waveguide segments along a length of the waveguide structure, wherein the alternating segments are configured such that supercontinuum spectral generation of optical pulses traversing the waveguide structure is affected in at least one or both of the AD and ND segments, wherein the optical pulses are temporally compressed in one of the segment types and temporally expanded in the other one of the segment types and spectral clamping is absent in both segment types to thereby generate a second plurality of channels greater in number than the first plurality of channels; and a modulator unit configured to receive the optical pulses from the waveguide structure and individually modulate at least some of the channels in the second plurality of channels

60. The optical modulator of claim 59, wherein the modulator unit includes a first arrayed waveguide grating (AWG) configured to demultiplex the channels in the second plurality of channels, a plurality of modulators each configured to modulate one of the demultiplexed channels in the second plurality of channels, and a second AWG configured to multiplex the modulated channels received from the plurality of modulators.
